(19) United States
(12) Patent Application Publication
(10) Pub. No.: US 2025/0002509 A1
(43) Pub. Date: Jan. 2, 2025

(54) PROCESS FOR PREPARING ORGANOTIN COMPOUNDS

(71) Applicant: ENTEGRIS, INC., Billerica, MA (US)

(72) Inventors: David M. Ermert, Danbury, CT (US); Thomas M. Cameron, Newtown, CT (US)

(21) Appl. No.: 18/884,024

(22) Filed: Sep. 12, 2024

Related U.S. Application Data
(62) Division of application No. 17/843,021, filed on Jun. 17, 2022.
(60) Provisional application No. 63/212,251, filed on Jun. 18, 2021.

(51) Int. Cl. C07F 7/22

(52) U.S. Cl. CPC C07F 7/2208; C07F 7/2284

(57) ABSTRACT

The invention provides a facile process for preparing certain organotin compounds having alkyl and aryl substituents. These compounds are useful as intermediates in the synthesis of certain alkylamino- and alkoxy-substituted alkyl tin compounds, which are in turn useful as precursors in the deposition of high-purity tin oxide films in, for example, extreme ultraviolet light (EUV) lithography techniques used in microelectronic device manufacturing.

### CROSS-REFERENCE TO RELATED APPLICATIONS

This application is a divisional of U.S. patent application Ser. No. 17/873,021, filed Jun. 17, 2022, which claims the benefit under 35 USC 119 of U.S. Provisional Patent Application No. 63/212,251, filed Jun. 18, 2021, the disclosure of which is hereby incorporated herein by reference in its entirety.

### TECHNICAL FIELD

This invention belongs to the field of organotin chemistry, and, in particular, relates to a facile process for preparing certain organotin intermediates.

### BACKGROUND

Certain organotin compounds have been shown to be useful in the deposition of highly pure tin (IV) oxide in applications such as extreme ultraviolet (EUV) lithography techniques used in the manufacture of certain microelectronic devices.

Of particular interest are organotin compounds having a combination of alkylamino groups (or alkoxy groups) and alkyl groups, which are useful as liquid precursors in the deposition of tin-containing films onto microelectronic device substrates. Accordingly, there is a need for improved methodology for manufacturing such organotin compounds in highly pure forms for use in the deposition of highly pure tin oxide films.

### SUMMARY

Provided is a facile process for preparing certain organotin compounds having alkyl, aryl, or halo substituents. These compounds are useful as intermediates in the synthesis of certain alkylamino- and alkoxy-substituted alkyl tin compounds useful as precursors in the deposition of high-purity tin oxide films in, for example, extreme ultraviolet light (EUV) lithography techniques used in microelectronic device manufacturing. For example, the process of the invention can be used to prepare isopropyltriphenyl tin, which can then be reacted with tin tetrachloride, followed by dimethylamine and lithium dimethylamide, to afford tris (dimethylamido) isopropyl tin.

### BRIEF DESCRIPTION OF THE DRAWINGS

FIG. 1 is a ¹H- NMR of the Ph₃Sn—iPr (isopropyl triphenyl tin) of Example 1, recorded in CDCl₃.

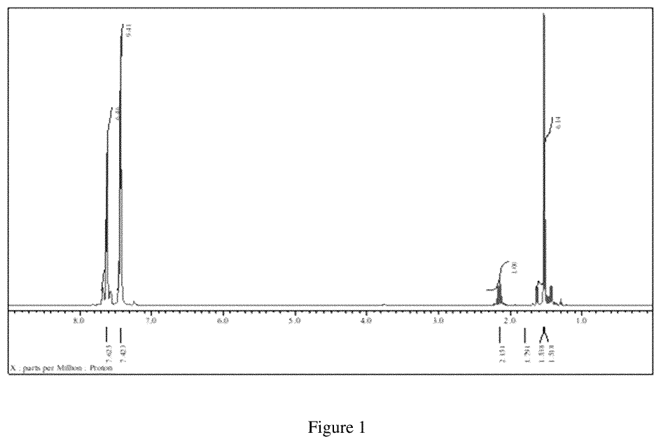

FIG. 2 is a ¹¹⁹Sn- NMR of the Ph₃Sn—iPr of Example 1, recorded in CDCl₃.

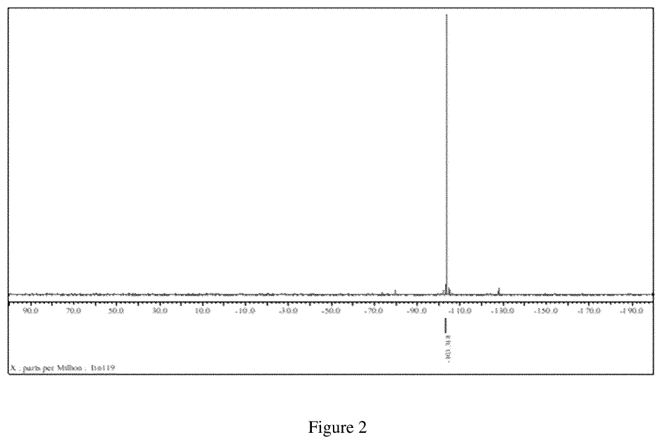

FIG. 3 is a ¹¹⁹Sn- NMR of the iPrSnI₃ of Example 2, recorded in 2-Iodopropane.

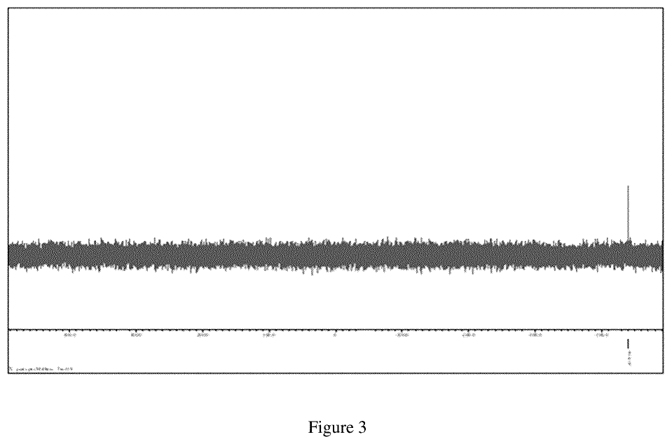

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g. 1 to 5 includes 1, 1.5, 2, 2.75, 3, 3.80, 4 and 5).

In a first aspect, the present disclosure provides a process for preparing a compound of Formula (I):

(Q)₃SnR (I),

wherein Q is chosen from
(a) phenyl,
(b) a group of the formula (C₁-C₁₂ alkyl)₂N—,
(c) a group of the formula (C₁-C₁₂ alkyl-O)—; and
(d) a halide (F, Cl, Br, I) and

wherein R is a C₁-C₁₂ alkyl group,

the process comprising combining a compound of the formula SnX₂, wherein X is chosen from fluoro, chloro, bromo, and iodo, with a molar excess of a compound of the formula Q—M, wherein M is chosen from Li, Na, and K, followed by combining with a compound of the formula R—X.

In one embodiment of this process, Q is chosen from (a), (b), or (c). As a specific example of this embodiment, the compound of the formula Q—M is generally added slowly (while controlling the resulting exothermic reaction) to a reaction mixture comprising a dihalo tin compound (SnX₂) and an aprotic solvent, for example an ether such as tetrahydrofuran, diethyl ether, di-n-butyl ether, dimethoxyethane, and the like to form a compound of the formula Q₃SnM. As noted above, a molar excess of the compound of the formula Q—M is utilized, based on the starting amount of the compound of the formula SnX₂. In one embodiment, approximately 2.7 to about 3.3 molar equivalents is utilized, such as 2.8 to about 3.2 molar equivalents or 2.9 to about 3.1 molar equivalents, and in another embodiment, about 3 molar equivalents are utilized. Once addition of the compound of the formula Q—M is complete, the reaction mixture can be heated to a temperature above ambient temperature, for example about 40° C. to 80° C., or about 55° C. to 65° C., for a period of time sufficient to ensure complete reaction of these two species. Next, a generally equimolar amount of a compound of the formula R—X is added to the reaction mixture, which then affords the desired product of Formula (I). In certain embodiments, the compound of the formula R—X is added in about 0.7 to about 1.3 molar equivalents, such as about 0.8 to about 1.2 molar equivalents or about 0.9 to about 1.1 molar equivalents, based on the amount of starting material of the formula SnX₂.

In another embodiment of the process, Q is chosen from (d). As a specific example of this embodiment, a compound of the formula Q—M is added to a dihalo tin compound (SnX₂) in a ratio of from 1.2:1 to 1:1.2, such as a ratio of from 1.1:1 to 1:1.2, and preferably in a 1:1 ratio, wherein Q is a halide. Once addition of the compound of the formula Q—M is complete, the reaction mixture can be heated to a temperature above ambient temperature, for example about 180° C. to 220° C., for a period of time sufficient to ensure complete reaction to form a compound having the formula Q₃SnM. Next, a general excess of R—X is added to the reaction mixture. Once addition of compound R—X is complete, the reaction mixture can be heated to a temperature above ambient temperature, for example about 90° C. to 140° C., for a period of time sufficient to ensure complete reaction of these species, which then affords the desired product of Formula (I), wherein Q is a halide. In certain embodiments, the compound of the formula R—X is added in about 4 to about 8 molar equivalents, based on the amount of starting material of the formula SnX₂.

In this process, R can be chosen from C₁-C₁₂ alkyl groups, which can be straight or branched-chain alkyl groups such as methyl, ethyl, propyl, butyl, isopropyl, isobutyl, sec-butyl, etc. In addition, R can be a cyclic C₁-C₅ group such as a cyclopropyl group. Also, R may be an unsaturated C₁-C₅ group such as a vinyl group or an acetylenyl group. Any of these R groups may be further substituted, such as with one or more halogen groups or ether groups. For example, R may be a fluorinated alkyl group having the formula —(CH₂)ₙ(CHₐF_{b})ₘ, wherein m is 1 to 5 and m+n is 1 to 5 and wherein b is 1 to 3 and a+b=3, including a monofluorinated C₁-C₅ alkyl group, such as a —CH₂F or —CH₂CH₂F group, and a perfluorinated C₁-C₅ group, such as a —CF₃ or CF₂CF₃ group. Alternatively, R may be an alkylether group, wherein the alkyl portion is a C₁-C₅ alkyl group.

In one embodiment, X is chosen from chloro or bromo. For example, the reactant of the formula R—X, in one embodiment, can be 2-bromopropane or 2-chloropropane.

Compounds of Formula (I), such as wherein Q is phenyl, a group of the formula (C₁-C₁₂ alkyl)₂N—, or a group of the formula C₁-C₁₂ alkyl-O—, are useful as intermediates in the synthesis of certain dialkylamido organotin precursor compounds, which compounds are useful in the vapor deposition of tin-containing films onto a surface of a microelectronic device. In one embodiment, the compound of Formula (I) is isopropyl triphenyltin.

In one specific embodiment of this first aspect, the invention provides a process for preparing a compound of the formula

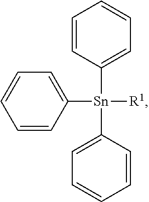

wherein R¹ is C₁-C₆ alkyl, which comprises contacting a compound of the formula SnX₂, wherein X is chloro or bromo, with a molar excess of a compound of the formula (Ph)Li, wherein Ph is phenyl, followed by addition of a compound of the formula R¹X. In one embodiment, R¹ is isopropyl and X is chloro.

As noted above, the compounds of Formula (I), such as wherein Q is phenyl, a group of the formula (C₁-C₁₂ alkyl)₂N—, a group of the formula C₁-C₁₂ alkyl-O—, or a halide such as F, Cl, Br, or I, are useful as intermediates in the formation of dialkylamido alkyl tin compounds. Thus, in a second aspect, the disclosure provides a process for preparing a compound of Formula (II):

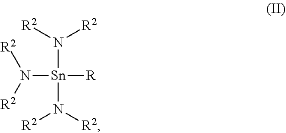

wherein R is a C₁-C₁₂ alkyl group and R² is a C₁-C₁₂ alkyl group, which comprises
(a) contacting a compound of the formula SnX₂, wherein X is chosen from fluoro, chloro, bromo, and iodo, with a molar excess of a compound of the formula Q—M, wherein M is chosen from Li, Na, and K, and Q is phenyl, a group of the formula (C₁-C₁₂ alkyl)₂N—, or a group of the formula C₁-C₁₂ alkyl-O—,
(b) adding a compound of the formula R—X, wherein R is a C₁-C₁₂ alkyl group, to afford a compound of the formula (Q)₃SnR,
(c) reacting with a tin (IV) halide to afford an alkyl trihalotin, and
(d) reacting with a compound of the formula (R²)₂NH and with a compound of the formula (R²)₂N—M.

In this process, steps (a) and (b) are analogous to those recited above in the first aspect. As a specific example, a compound such as [phenyl]₃Sn-[isopropyl] may be formed by combining a tin (II) dihalide, such as SnCl₂, and (Ph)Li, and further combining with an isopropyl halide. The resulting [phenyl]₃Sn-[isopropyl] may be further reacted with a tin (IV) halide such as SnCl₄, to afford a trihalotin intermediate, such as isopropyltin trichloride, which can then be reacted with a dialkylamine of the formula (R²)₂NH, such as dimethylamine, and a compound of the formula (R²)₂N—M, such as lithium dimethylamide, to provide a compound of the Formula (IIa):

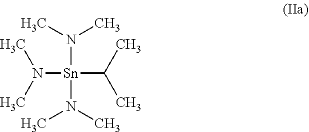

Alternatively, the disclosure also provides a process for preparing a compound of Formula (II), wherein R is a C₁-C₁₂ alkyl group and R² is a C₁-C₁₂ alkyl group, which comprises
(a) contacting a compound of the formula SnX₂, wherein X is chosen from fluoro, chloro, bromo, and iodo, with a compound of the formula Q—M, wherein M is chosen from Li, Na, and K, and Q is a halide,
(b) adding a compound of the formula R—X, wherein R is a C₁-C₁₂ alkyl group; to afford a compound of the formula (Q)₃SnR, and
(c) reacting with a compound of the formula (R²)₂NH and with a compound of the formula (R²)₂N—M.

In this process, steps (a) and (b) are analogous to those recited above in the first aspect. As a specific example, an alkyl tin trihalide, such as isopropyl tin trichloride, may be formed by reacting metal halide (M—X) such as KCl and a tin (II) halide (SnX₂) such as SnCl₂, to afford a trihalotin intermediate, which can then be reacted with an alkyl halide (R—X) such as iodopropane to form a compound having the formula Q₃SnR, such as [chloro]₃Sn-[isopropyl]. As above, this can then be reacted with a dialkylamine of the formula (R²)₂NH, such as dimethyamine and a metal amide of the formula (R²)₂NM, such as lithium dimethylamide, to provide a compound of Formula (IIa).

In certain embodiments, Q is a group of the formula (C₁-C₄ alkyl)₂N—, and is chosen from groups of the formulae:
a. (CH₃)₂N—;
b. (CH₃CH₂)₂N—;
c. (n-propyl)₂N—;
d. (isopropyl)₂N—;
e. (tert-butyl)₂N—;
f. (sec-butyl)₂N—; and
g. (n-butyl)₂N—.

In other embodiments, R is a group of the formula C₁-C₄ alkyl-O—, and is chosen from groups of the formulae:
a. CH₃O—;
b. CH₃CH₂O —;
a. n-propyl-O—;
b. isopropyl-O—;
c. tert-butyl-O—;
d. sec-butyl-O—; and
e. n-butyl-O—.

### EXAMPLES

### Example 1—Synthesis of IsopropyltriphenylTin (Ph₃SniPr)

In a nitrogen-filled glovebox, SnCl₂ (15 g, 78.2 mmol) was loaded into a 250 ml roundbottom flask equipped with a magnetic stir bar and diluted with THF (˜50 mL) to form a slightly cloudy solution. The flask was placed on a 250 ml heating mantle and PhLi (1.9M (n—Bu)₂O, 129 mL, 246 mmol) was slowly added via syringe. Upon addition, the reaction immediately presented as a dark red mixture, exhibited an exotherm, and began to reflux. The PhLi was added slowly to control the exotherm (2.5 syringes worth over ˜20 mins) and upon complete addition the reaction presented as a dark red/brown mixture. Additional THF was added (˜50 mL), the flask was equipped with a condenser, and the reaction was heated at 60° C. with stirring for 6 hrs.

After this time, the reaction presented as a dark brown mixture. 2-Chloropropane was weighed in a 40 mL vial and added to the mixture rapidly via pipette, whereby, upon complete addition, the reaction had changed to a light brown mixture, which was stirred at room temperature. The solvent was removed from the reaction under reduced pressure and the resulting tacky yellow mixture was brought out of the glovebox and placed in a fume hood. The product was dissolved in dichloromethane (˜50 mL) and washed with DI H₂O (3×100 mL) in a separatory funnel. After the third water washing, the combined organic layers were dried with MgSO₄, filtered through a disposable polyethylene filter frit, and the resulting peach/yellow solution dried under reduced pressure to yield a pale yellow solid: 20.2 g (65.7%).

¹H-NMR (CDCl₃ 400 MHZ); d, 6H, 1.528 ppm; sept. 1H, 2.15 ppm; m, 9H, 7.42 ppm; m, 6H, 7.63 ppm. ¹¹⁹Sn{¹H}-NMR (CDCl₃, 150 MHz); −103.318 ppm.

### Example 2—Synthesis of IsopropylTin Triiodide (iPrSnI₃)

In a nitrogen-filled glovebox, KCl (1.93 g, 26.0 mmol) and SnCl₂ (5 g, 26.0 mmol) were combined in a 40 mL vial equipped with a magnetic stir bar and heated at 195° C., whereby, after heating for one hour the reaction presented as a light-yellow liquid. The mixture was cooled to room temperature, solidifying into a white solid. 2-iodopropane (26.5 g, 156 mmol) was added to the reaction and the mixture stirred at 125° C. for 12 hours, at which time, the reaction presented as a yellow/orange mixture. ¹H- and ¹¹⁹Sn-NMR recorded on an aliquot of the mother liquor are consistent with generation of iPrSnI₃.

¹H-NMR (400 MHZ, 2-iodopropane, 298K): 0.14 (d, 6H); 2.82 (sept, 1H) ppm; ¹¹⁹Sn{¹H}-NMR (149 MHZ, 2-iodopropane, 298K): —439.54 ppm.

### Aspects

In a first aspect, the disclosure provides a process for preparing a compound of Formula (I):

(Q)₃SnR (I),

wherein Q is chosen from
(a) phenyl,
(b) a group of the formula (C₁-C₁₂ alkyl)₂N—,
(c) a group of the formula C₁-C₁₂ alkyl-O—; and
(d) a halide, and

wherein R is a C₁-C₁₂ alkyl group, the process comprising contacting a compound of the formula SnX₂, wherein X is chosen from fluoro, chloro, bromo, and iodo, with a molar excess of a compound of the formula Q—M, wherein M is chosen from Li, Na, and K, followed by combining with a compound of the formula R—X.

In a second aspect, the disclosure provides the process of the first aspect, wherein Q is phenyl, a group of the formula (C₁-C₁₂ alkyl)₂N—, or a group of the formula C₁-C₁₂ alkyl-O—

In a third aspect, the disclosure provides the process of the first or second aspect, wherein M is Li.

In a fourth aspect, the disclosure provides the process of any of the first through third aspects, wherein R is a methyl, ethyl, propyl, isopropyl, n-butyl, t-butyl, sec-butyl, n-pentyl, isopentyl, or sec-pentyl group.

In a fifth aspect, the disclosure provides the process of any of the first through fourth aspects, wherein R is a cyclic C₁-C₅ group.

In a sixth aspect, the disclosure provides the process of any one of the first through fourth aspects, wherein R is a vinyl group or an acetylenyl group.

In a seventh aspect, the disclosure provides the process of any one of the first through the fourth aspects, wherein R is further substituted with one or more halogen groups or ether groups.

In an eighth aspect, the disclosure provides the process of any of the first through fourth, aspects, wherein R is a perfluorinated C₁-C₅ group.

In a ninth aspect, the disclosure provides the process of any of the first through fourth aspects, wherein R is an alkylether group having an alkyl portion that is a C₁-C₅ group.

In a tenth aspect, the disclosure provides the process of any of the second through ninth aspects, wherein the molar excess of the compound of the formula Q—M is about 2.7 to about 3.3, based on the amount of the compound of the formula SnX₂.

In an eleventh aspect, the disclosure provides the process of any of the first through tenth aspects, herein Q is phenyl, X is chloro, R is isopropyl, and M is lithium.

In a twelfth aspect, the disclosure provides the process of any of the first through eleventh aspects, wherein the compound of Formula (I) is

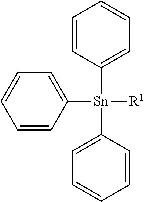

wherein R¹ is C₁-C₆ alkyl.

In a thirteenth aspect, the disclosure provides the process of the twelfth aspect, wherein R¹ is isopropyl and X is chloro.

In a fourteenth aspect, the disclosure provides a process of the first aspect, wherein Q is a halide.

In a fifteenth aspect, the disclosure provides a process of the fourteenth aspect, wherein the compound of the compound of formula Q—M and the compound of the formula SnX₂ are combined in a ratio of from 1.2:1 to 1:1.2.

In a sixteenth aspect, the disclosure provides a process for preparing a compound of Formula (II):

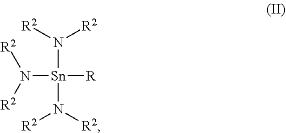

wherein R is a C₁-C₁₂ alkyl group and R² is a C₁-C₁₂ alkyl group, wherein the process comprises
(a) contacting a compound of the formula SnX₂, wherein X is chosen from fluoro, chloro, bromo, and iodo, with a molar excess of a compound of the formula Q—M, wherein M is chosen from Li, Na, and K, and Q is phenyl, a group of the formula (C₁-C₁₂ alkyl)₂N—, or a group of the formula C₁-C₁₂ alkyl-O—,
(b) adding a compound of the formula R—X, wherein R is a C₁-C₁₂ alkyl group, to afford a compound of the formula (Q)₃SnR,
(c) reacting with a tin (IV) halide to afford an alkyl trihalotin, and
(d) reacting with a compound of the formula (R²)₂NH and with a compound of the formula (R²)₂N—M;
   or wherein the process comprises
(a) contacting a compound of the formula SnX₂, wherein X is chosen from fluoro, chloro, bromo, and iodo, with a compound of the formula Q—M, wherein M is chosen from Li, Na, and K, and Q is a halide,
(b) adding a compound of the formula R—X, wherein R is a C₁-C₁₂ alkyl group; to afford a compound of the formula (Q)₃SnR, and
(c) reacting with a compound of the formula (R²)₂NH and with a compound of the formula (R²)₂N—M.

In a seventeenth, the disclosure provides the process of the sixteenth aspect, comprising
(a) contacting a compound of the formula SnX₂, wherein X is chosen from fluoro, chloro, bromo, and iodo, with a molar excess of a compound of the formula Q—M, wherein M is chosen from Li, Na, and K, and Q is phenyl, a group of the formula (C₁-C₁₂ alkyl)₂N—, or a group of the formula C₁-C₁₂ alkyl-O—,
(b) adding a compound of the formula R—X, wherein R is a C₁-C₁₂ alkyl group, to afford a compound of the formula (Q)₃SnR,
(c) reacting with a tin (IV) halide to afford an alkyl trihalotin, and
(d) reacting with a compound of the formula (R²)₂NH and with a compound of the formula (R²)₂N—M.

In an eighteenth aspect, the disclosure provides the process of the sixteenth aspect, comprising
(a) contacting a compound of the formula SnX₂, wherein X is chosen from fluoro, chloro, bromo, and iodo, with a compound of the formula Q—M, wherein M is chosen from Li, Na, and K, and Q is a halide,
(b) adding a compound of the formula R—X, wherein R is a C₁-C₁₂ alkyl group; to afford a compound of the formula (Q)₃SnR, and
(c) reacting with a compound of the formula (R²)₂NH and with a compound of the formula (R²)₂N—M.

In a nineteenth aspect, the disclosure provides the process of any of the sixteenth through eighteenth aspects, wherein the compound of Formula (II) is

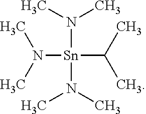

In a twentieth aspect, the disclosure provides a compound having the formula (Q)₃SnR, wherein Q is phenyl and wherein R is selected from the group consisting of:

a methyl, ethyl, propyl, isopropyl, n-butyl, t-butyl, sec-butyl, n-pentyl, isopentyl, or sec-pentyl group,

a cyclic C₁-C₅ group,

a vinyl group or an acetylenyl group.

a perfluorinated C₁-C₅ group, and

an alkylether group, wherein the alkyl portion is a C₁-C₅ group.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

1-4. (canceled)

5. A process for preparing a compound of Formula (I):
(Q)₃SnR (I),
wherein Q is chosen from a halide, and
wherein R is a C₁-C₁₂ alkyl group,
the process comprising contacting a compound of the formula SnX₂, wherein X is chosen from fluoro, chloro, bromo, and iodo, with a molar excess of a compound of the formula Q—M, wherein M is chosen from Li, Na, and K, followed by combining with a compound of the formula R—X.

6. The process of claim 5, wherein M is Li.

7. The process of claim 5, wherein R is a methyl, ethyl, propyl, isopropyl, n-butyl, t-butyl, sec-butyl, n-pentyl, isopentyl, or sec-pentyl group.

8. The process of claim 5, wherein R is a cyclic C₁-C₅ group.

9. The process of claim 5, wherein R is a vinyl group or an acetylenyl group.

10. The process of claim 5, wherein R is further substituted with one or more halogen groups or ether groups.

11. The process of claim 5, wherein R is a perfluorinated C₁-C₅ group.

12. The process of claim 5, wherein R is an alkylether group, wherein the alkyl portion is a C₁-C₅ group.
